(19) United States
(12) Patent Application Publication
(10) Pub. No.: US 2011/0183204 A1
(43) Pub. Date: Jul. 28, 2011

(54) Polymer materials as binder for a CFx cathode

(75) Inventors: Simon Christopher Jones, Los Angeles, CA (US); Sohrab Hossain, West Covina, CA (US)

(73) Assignee: Contour Energy Systems, Inc., Azusa, CA (US)

(21) Appl. No.: 13/010,431

(22) Filed: Jan. 20, 2011

Related U.S. Application Data
(60) Provisional application No. 61/298,156, filed on Jan. 25, 2010.

(51) Int. Cl. H01M 4/62; H01M 4/82

(52) U.S. Cl. 429/217; 29/623.1

(57) ABSTRACT

Lithium anode based battery systems can use polymeric binding materials to act as particulate binders for fluorinated carbon based electrodes. The binders mechanically hold electrochemically active particles together, while inhibiting lithium fluoride crystallization that generates unwanted heat release in a discharging battery. Polymeric binders that include positively-charged groups, negatively-charged groups, electron deficient π-anion receptor groups, or boronate-based fluoride receptor group can be used alone or in combination.

### RELATED APPLICATION

This application claims the benefit of U.S. Provisional Application No. 61/298,156, filed Jan. 25, 2010, the disclosure of which is incorporated by reference herein.

### FIELD OF THE INVENTION

Battery systems can use polymeric materials to act as particulate binders for fluorinated carbon based electrodes. The binders hold electrochemically active particles together, while inhibiting lithium fluoride crystallization that generates unwanted heat release in a discharging battery.

### BACKGROUND

Electrodes for advanced battery systems can be formed from a wide range of electrochemically active liquids, thin films, porous solids, or particulate materials. In addition to electrochemically active materials that react to create usable current, electrodes can include both stabilizing additives and conductive diluents. Stabilizing additives can alter chemical reactions for improved battery performance, reduce unwanted by-products, or reduce corrosion. Conductive diluents are electrically conductive materials such as carbon black, graphite, metal particles, conductive polymers (e.g., polymers having a conjugated network of double bonds such as polypyrrole and polyacetylene), and mixtures thereof.

For best performance, particulate electrolyte materials and electrically conductive materials are commonly bound together with binders that mechanically strengthen the electrolyte to ensure formation of a cohesive mass. As an example, fine particles or granules of precursor electrode materials can be ball milled or otherwise processed to form a fine powder mixture of the electrode precursors. The electrode precursor powders are mixed with small amounts of a binder that is typically selected to be chemically inert. Examples include mineral oils, glycerol, and polymers that encourage good particle to particle contact. Polymeric binders can include a polymeric material and extractable plasticizer suitable for forming a bound porous composite. Other binder examples include halogenated hydrocarbon polymers (such as poly(vinylidene chloride) and poly((dichloro-1,4-phenylene)ethylene), fluorinated urethanes, fluorinated epoxides, fluorinated acrylics, copolymers of halogenated hydrocarbon polymers, epoxides, ethylene propylene diamine termonomer (EPDM), ethylene propylene diamine termonomer (EPDM), polyvinylidene difluoride (PVDF), hexafluoropropylene (HFP), ethylene acrylic acid copolymer (EAA), ethylene vinyl acetate copolymer (EVA), EAA/EVA copolymers, PVDF/HFP copolymers, and mixtures thereof.

One particularly suitable binder for electrodes that include electrochemically active fluorinated or sub-fluorinated carbon fluorides are partially fluorinated polymeric binders such as PTFE or PVDF. These materials provide mechanical strength to hold together particles of the carbon fluorides and are stable and easily processed. Other exemplary binders that can be used include poly(ethylene oxide) (PEO), a poly(acrylonitrile) (PAN), and poly(ethylene-co-tetrafluoroethylene) (PETFE). The binders typically represent about 1 wt. % to about 10 wt. % of the composition, and the amount used is as kept small as possible to achieve a desired mechanical strength while maximizing battery energy density (which is reduced by addition of such inert materials).

### BRIEF DESCRIPTION OF THE DRAWINGS

In the accompanying drawings:

FIG. 1 is a simplified Born-Haber cycle for lithium/carbon fluoride discharge; and

FIG. 2 illustrates representative LiF crystallization inhibiting compounds.

### DETAILED DESCRIPTION

Primary batteries incorporating a lithium anode physically separated from carbon fluoride containing cathode, with both anode and cathode immersed in a common ion transporting electrolyte, have been commercially available for many years. Carbon fluorides can be synthesized by direct fluorination of carbon, in the form of graphite or coke, or advanced nanomaterials such as carbon nanotubes, cones, or rods, with fluorine gas at temperatures of 300° C. to over 600° C. The value of x typically ranges from 1.0 to 1.2 for fully fluorinated carbon and from about 0.06 to about 0.99 for sub-fluorinated carbon. Subfluorinated carbon mixtures for batteries that have x from about 0.63 to about 0.95 are suitable for many applications. Carbon monofluoride based cathodes with x equal to 1 (CF₁) have long been used for batteries requiring high energy density, good performance at high temperatures, and with flat discharge voltage characteristics. More recently, subfluorinated carbon fluoride battery systems have been developed because of the high discharge rate, lower internal resistance, and improved performance characteristics as compared to carbon monofluoride batteries.

Typical binders used in CFₓ cathode formulations (e.g., PTFE, PVDF) provide mechanical strength to hold together carbon fluoride particles but may be regarded as otherwise inactive. This adds to battery cell weight, but does not provide additional energy, contributing only parasitic mass to the battery cell. Energy density of batteries can be improved at higher rate by use of binder materials that serve an electrochemical or chemical function in addition to adding mechanical particle binding. These polymers need to have reasonably high molecular weight and electrolyte solvent resistance (enabling satisfactory adhesion of the cathode formulation), and feature one or more functional groups to enhance cathode electrochemical performance. In particular, one class of polymers that contain functional groups designed to mitigate heat generation from the discharge reaction by inhibiting LiF crystallization would be very useful for Li/CFₓ primary batteries.

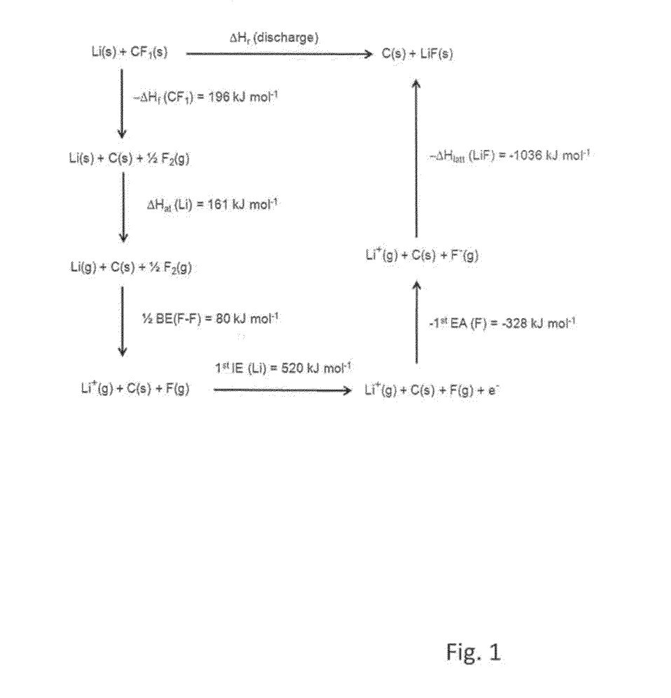

Detailed micro-calorimetric studies indicate the majority of heat generated through Li/CFₓ discharge arises from C—F bond breaking to form LiF, and suggest the reaction is a simple two-phase process. Discharge reaction energetics of a simplified Born-Haber cycle (ignoring solvation effects) is illustrated in FIG. 1, and suggest a major contribution to the heat of reaction comes from the large lattice enthalpy of LiF. Therefore, to achieve the maximum energy extraction efficiency and rate capability for a carbon fluoride electrode based battery system, inhibiting the formation of crystalline LiF can be considered. If conditions could be found to render LiF in amorphous rather than crystalline form, then heat evolved during discharge would be considerably reduced (a reduction of around 20% has been observed for amorphous vs. crystalline Si).

To encourage formation of amorphous LiF instead of crystalline LiF, polymers that substantially inhibit the crystallization of inorganic materials can be used. In certain embodiments, polymers that act by coordinating to one or more faces of a growing crystal can be used, resulting in effectively limited crystal deposition and/or formation of amorphous material. Such inhibitor polymers can function at very low concentrations (as low as 1 mg/L, or 1 ppm), in part because a large number of functional groups are present on a flexible backbone that can coordinate to several growing crystals at once with relaxed lattice-matching requirements. As will be appreciated, the functional group selected should be specific to the material type.

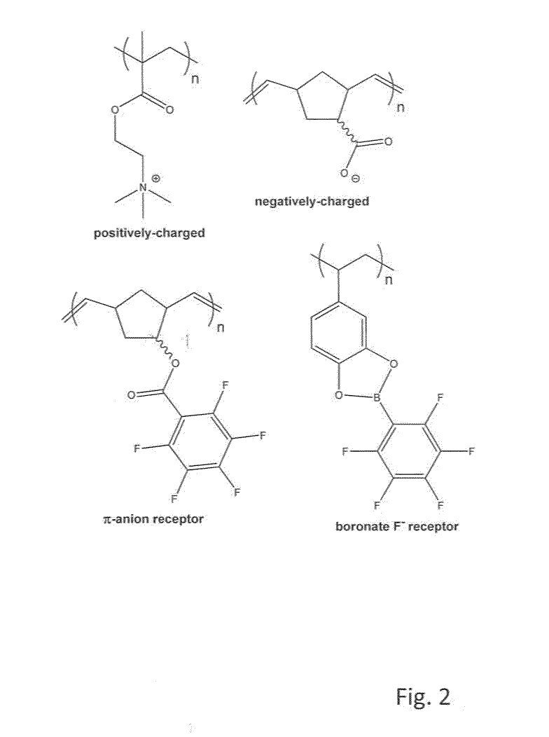

LiF crystallization inhibition can be promoted by use of several functional group classes, including but not limited to significantly positively-charged groups, negatively-charged groups, electron-deficient π-anion receptor groups and boronate-based fluoride receptor groups, incorporated onto inert polymer backbones that are capable of being synthesized in high molecular weight. FIG. 2 illustrates several embodiments of a polymer linked to a suitable functional group

These polymers have structure [(backbone)-(spacer)-(functional group)]ₙ where:
a. “backbone” may be derived from polymer chain types such as (but not limited to) poly(cycloalkene), poly(acrylate), poly(styrene), poly(ethylene), poly(acrylonitrile), poly(ester)
b. “spacer” may be a substituted or unsubstituted, linear or branched, C₁ to C₅₀ aliphatic or cyclic aliphatic, fluoroalkyl, oligo(ethyleneglycol), aryl or substituted aryl group
c. “functional group” may be a positively-charged group (e.g. alkylammonium group, alkylphosphonium group), negatively-charged group (e.g. sulfonate group, carboxylate group), fluorinated aromatic group (e.g. pentafluorobenzyl group, 3,5-bis(trifluoromethyl)phenyl group), boronate group (e.g. (pentafluorophenyl)catecholborane, tris(pentafluorophenyl)borane)), boroxin group, hydrogen bond donor group (e.g. alcohol, amine, thiol), hydrogen bond acceptor group (e.g. alkoxide, amine, thiolate).

In addition, copolymers of various types containing at least in part the above structural motifs may be used to inhibit LiF crystal formation.

All references throughout this application, for example non-patent literature documents or other source material; are hereby incorporated by reference herein in their entireties, as though individually incorporated by reference, to the extent each reference is at least partially not inconsistent with the disclosure in this application The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed in various embodiments; optional features, modification and variation of the concepts herein disclosed may be resorted to by those skilled in the art, and such modifications and variations are considered to be within the scope of this invention as defined by the claims. As will be understood by one of skill in the art, methods and devices useful for the present methods can include a large number of optional composition and processing elements and steps. When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. Many of the molecules disclosed herein contain one or more ionizable groups. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt. Every formulation or combination of components described or exemplified herein can be used to practice the invention, unless otherwise stated. Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the following claims.

What is claimed is:

1. A battery comprising
an anode having at least some Li reactant;
a cathode having at least some CFₓ particle reactants;
a polymeric binder holding at least some of the CFₓ particles together, the polymeric binder acting to inhibit formation of crystalline LiF during battery discharge.

2. The polymeric binder of claim 1, further comprising at least one functional group incorporated onto a polymer backbone.

3. The polymeric binder of claim 2, wherein the functional group is a positively-charged group.

4. The polymeric binder of claim 2, wherein the functional group is a negatively-charged group.

5. The polymeric binder of claim 2, wherein the functional group is an electron deficient π-anion receptor group.

6. The polymeric binder of claim 2, wherein the functional group is a boronate-based fluoride receptor group.

7. The polymeric binder of claim 2, wherein the polymer backbone is inert.

8. The polymeric binder of claim 2, wherein the polymer backbone is selected from a group consisting of poly(cycloalkene), poly(acrylate), poly(styrene), poly(ethylene), poly(acrylonitrile), and poly(ester).

9. The polymeric binder of claim 2, wherein the functional group is attached to the polymer backbone with a spacer.

10. The polymeric binder of claim 9, wherein the polymer spacer is selected from a group consisting of substituted or unsubstituted carbon chains, linear or branched carbon chains, C₁ to C₅₀ aliphatic or cyclic aliphatic, fluoroalkyl, oligo(ethyleneglycol), aryl or substituted aryl group.

11. The battery of claim 1, wherein the CFₓ particles are subfluorinated to have x less than 1.

12. The battery of claim 1, wherein the CFₓ particles are subfluorinated to have x between about 0.06 and 0.99.

13. The battery of claim 1, wherein the CFₓ particles are subfluorinated to have x between about 0.63 and 0.95.

14. A method of assembling a battery comprising
providing an anode having at least some Li reactant;
providing a cathode separated from the anode and having at least some CFₓ particle reactants;
binding at least some of the CFₓ particles of the cathode together with a polymeric binder, the polymeric binder acting to inhibit formation of crystalline LiF during battery discharge, and
contacting the anode and cathode with an ion conducting electrolyte.

15. The method of claim 14, wherein the polymeric binder further comprises at least one functional group incorporated onto a polymer backbone.

16. The method of claim 15, wherein the functional group of the polymeric binder further comprises at least one of a positively-charged group, a negatively-charged group, an electron deficient π-anion receptor group, or a boronate-based fluoride receptor group.

17. The method of claim 15, wherein the functional group is attached to the polymer backbone with a spacer.

18. The method of claim 14, wherein the CFₓ particles are subfluorinated to have x less than 1.

19. The method of claim 14, wherein the CFₓ particles are subfluorinated to have x between about 0.63 and 0.95.
